(19) United States
(12) Patent Application Publication
(10) Pub. No.: US 2017/0222893 A1
(43) Pub. Date: Aug. 3, 2017

(54) Distributed Business Transaction Path Network Metrics

(71) Applicant: AppDynamics, Inc., San Francisco, CA (US)

(72) Inventors: Harish Nataraj, Berkeley, CA (US); Ajay Chandel, Fremont, CA (US); Prakash Kaligotla, San Francisco, CA (US); Naveen Kondapalli, San Ramon, CA (US)

(21) Appl. No.: 15/010,995

(22) Filed: Jan. 29, 2016

(51) Int. Cl. H04L 12/26; H04L 12/24; H04L 29/08

(52) U.S. Cl. CPC H04L 43/062; H04L 67/1097; H04L 43/04; H04L 41/046; H04L 67/025

(57) ABSTRACT

In one aspect, the performance of a network within the context of an application using that network is determined for a distributed business transaction. Network data is collected and correlated with a business transaction along with an application that uses the network and implements the distributed business transaction. The collected network data is culled, and the remaining data is rolled up into one or more metrics. The metrics, selected network data, and other data are reported in the context of the distributed business transaction. In this manner, specific network performance and architecture data associated with the distributed business transaction is reported along with application context information.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

Monitoring a web application helps to provide insight regarding bottle necks in communication, communication failures and other information regarding performance of the services that provide the web application. Most application monitoring tools provide a standard report regarding application performance. Though the typical report may be helpful for most users, it may not provide the particular information that an administrator wants to know.

In particular, application performance management (APM) systems typically only monitor the performance of an application. The APM systems usually do not provide performance details of a particular network over which an application executes. If network information is provided, it is typically only the time that the transaction spends on the network—there is no context or other data regarding the network. What is needed is an APM system that provides application-specific network performance details.

### SUMMARY

The present technology determines the performance of a network within the context of an application using that network. Network data is collected and correlated with a business transaction along with an application that uses the network and implements the distributed business transaction. The collected network data is culled, and the remaining data is rolled up into one or more metrics. The metrics, selected network data, and other data are reported in the context of the distributed business transaction. In this manner, specific network performance and architecture data associated with the distributed business transaction is reported along with application context information.

Some implementations may include a method for correlating network performance data for a distributed business transaction. Application data may be collected by a first agent installed on a first machine. The application data is collected during execution of an application, and the application is one of a plurality of applications on one or more machines that implement a distributed business transaction. Network data may be collected for a network by a second agent installed on the first machine. The network data may be collected during execution of the application while implementing a portion of the distributed business transaction over the network. The network data may be correlated to a distributed business transaction identifier. The correlated network data may be reported for the distributed business transaction from a remote server.

Some implementations may include a system for correlating network performance data for a distributed business transaction. The system may include a processor, memory, and one or more modules stored in memory and executable by the processor. When executed, the modules may collect application data by a first agent installed on a first machine, such that the application data is collected during execution of an application. The application may be one of a plurality of applications on one or more machines that implement a distributed business transaction, collect network data for a network by a second agent installed on the first machine. The network data may be collected during execution of the application while implementing a portion of the distributed business transaction over the network. Network data may be corrleated to a distributed business transaction identifier, and report the correlated network data for the distributed business transaction from a remote server.

### BRIEF DESCRIPTION OF THE DRAWINGS

FIG. 1 is a block diagram of an exemplary system for correlating an application and network performance data.

FIG. 2 is an exemplary method for providing a language agent in a monitoring system.

FIG. 3 is an exemplary method for providing a network agent in a monitoring system.

FIG. 4 is an exemplary method for providing a controller and a monitoring system.

FIG. 5 is an exemplary method for reporting correlated application data and network data.

FIG. 6 is an example of reporting application data and correlated network data.

FIG. 7 is a block diagram of an exemplary computing environment for implementing the present technology

### DETAILED DESCRIPTION

The present technology determines the performance of a network within the context of an application using that network. Network data is collected and correlated with a business transaction along with an application that uses the network and implements the distributed business transaction. The collected network data is culled, and the remaining data is rolled up into one or more metrics. The metrics, selected network data, and other data are reported in the context of the distributed business transaction. In this manner, specific network performance and architecture data associated with the distributed business transaction is reported along with application context information.

To provide distributed business transaction context to the network data, business transaction information is provided to a module, such as an agent, that collects the network data. The network agent receives the distributed transaction information along with an identification of the network data to associate with the distributed transaction information. The network agent collects network data, such as network flow group data, and identifies the network group data associated with the distributed transaction information. The network agent then generates metrics from the identified network group data, and transmits the metrics, the associated distributed transaction information, and optionally other data, such as the network group flow data, to a remote controller. The remote controller receives the data transmitted from the network agent, receives application metric data from other agents, and correlates the network flow group metrics and application metric data using the distributed transaction information. The controller may report the network performance data and architecture information to the user for a particular distributed business transaction. Correlating and reporting distributed business transaction and network performance data together brings relevant network level infrastructure visibility that directly correlates to distributed business transaction performance.

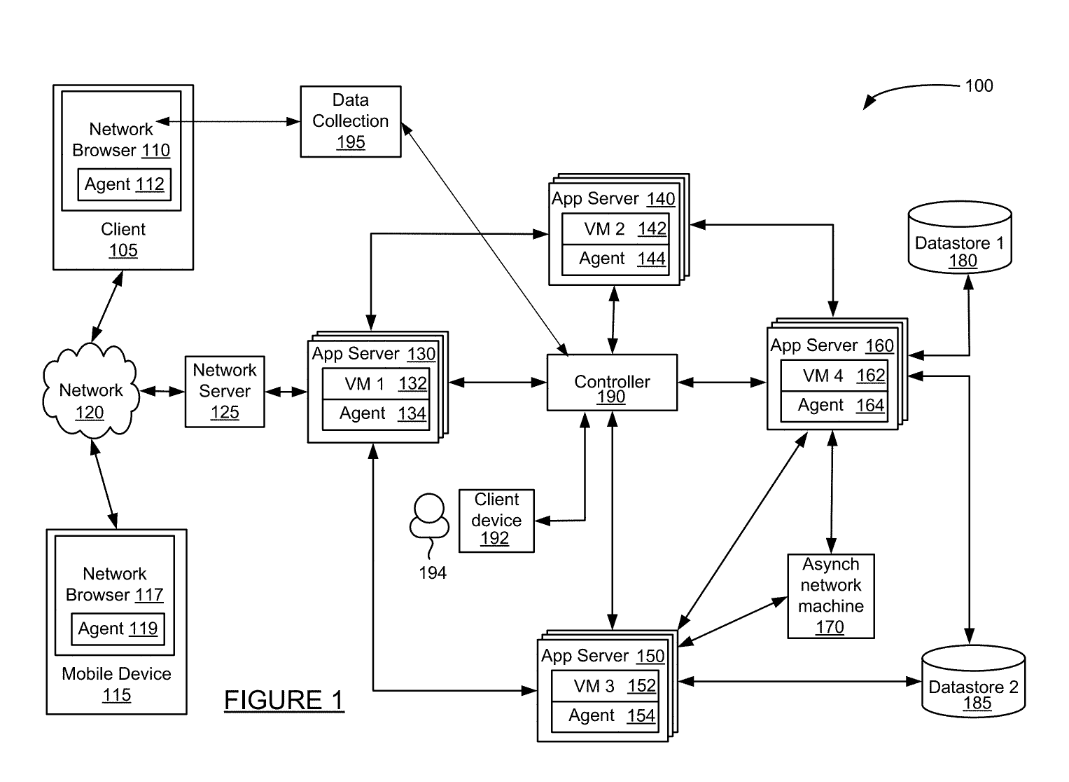

FIG. 1 is a block diagram of an exemplary system for correlating an application and network performance data. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130. When network 120 is the Internet, network server 125 may be implemented as a web server. Network server 125 and application server 130 may be implemented on separate or the same server or machine.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .NET, Node.JS, be implemented as a Java virtual machine, or include some other host type. Application server 130 may also include one or more agents 134 (i.e. “modules”), including a language agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, server 130 may include Java code, .NET code, PHP code, Ruby code, C code or other code to implement applications and process requests received from a remote source.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .NET, or C program), machine resources, network layer data, and communicate with byte instrumented code on application server 130 and one or more applications on application server 130.

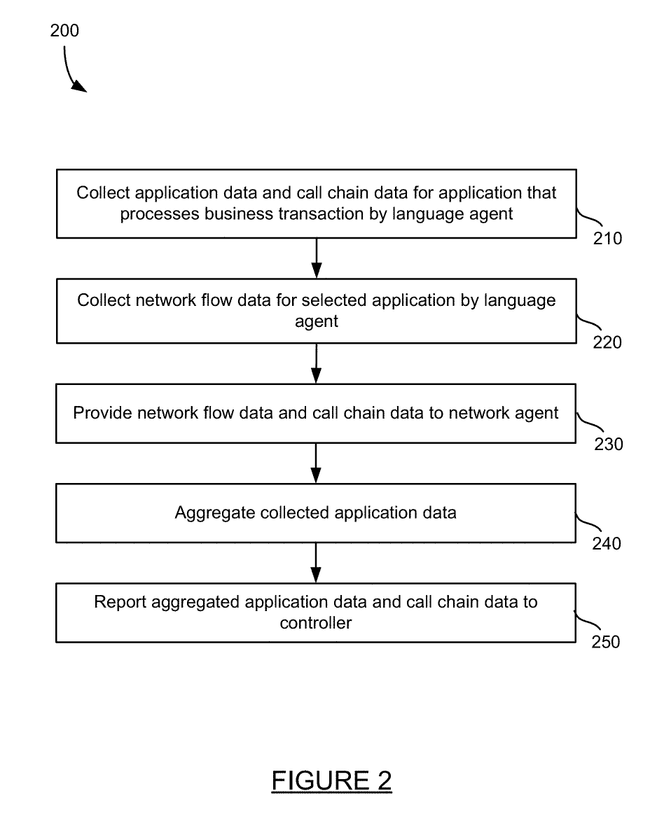

Each of agents 134, 144, 154 and 164 may include one or more agents, such as a language agents, machine agents, and network agents. A language agent may be a type of agent that is suitable to run on a particular host. Examples of language agents include a JAVA agent, .Net agent, PHP agent, and other agents. The machine agent may collect data from a particular machine on which it is installed. A network agent may capture network information, such as data collected from a socket. Agents are discussed in more detail below with respect to FIG. 2.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (memory, processor, and so on). A tier of nodes may include a plurality of nodes which may process a similar business transaction, may be located on the same server, may be associated with each other in some other way, or may not be associated with each other.

Agent 134 may create a request identifier for a request received by server 130 (for example, a request received by a client 105 or 115 associated with a user or another source). The request identifier may be sent to client 105 or mobile device 115, whichever device sent the request. In embodiments, the request identifier may be created when a data is collected and analyzed for a particular business transaction.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to configure collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as content page, e.g. a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

Each server, application or virtual machine (hereinafter collectively referred to as “host”) of FIG. 1 may include one more of a language agent, network agent or machine agent. A language agent may be an agent suitable to instrument or modify, collect data from, and reside on a host. The host may be a Java, PHP, .Net, Node.JS, or other type of platform. A language agent may collect flow data as well as data associated with the execution of a particular application. The language agent may instrument the lowest level of the application to gather the flow data. The flow data may indicate which tier is communicating which with which tier and on which port. In some instances, the flow data collected from the language agent includes a source IP, a source port, a destination IP, and a destination port. The language agent may report the application data and call chain data to a controller. The language agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent is installed. The network agent may collect data by intercepting and performing packet capture on packets coming in from a one or more sockets. The network agent may receive flow data from a language agent that is associated with applications to be monitored. For flows in the flow group data that match flow data provided by the language agent, the network agent rolls up the flow data to determine metrics such as TCP throughput, TCP loss, latency, retransmits, and optionally other metrics. The network agent may then reports the metrics, flow group data, and call chain data to a controller. The network agent may also make system calls at an application server to determine system information, such as for example a host status check, a network status check, socket status, and other information.

Each of the language agent and network agent may report data to the controller 210. Controller 210 may be implemented as a remote server that communicates with agents. The controller may receive metrics call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

FIG. 2 is an exemplary method for providing a language agent in a monitoring system. Application data and call chain data may be collected for an application that processes business transactions by a language agent at step 210. The call chain data may include a series of machines, services, and application tiers that have previously processed an application transaction.

Network flow data is collected for selected applications by a language agent at step 220. The network flow data may include a tuple of source IP, source port, destination IP, and destination port data. This network flow data is collected as a time series of tuples by monitoring the deepest levels of an application by the language agent.

Network flow data and call chain data are provided to a network agent at step 230. The network flow data and call chain data may be provided periodically, upon request of the network agent, or based on another event. The collected application data is aggregated by the language agent at step 240. The collected application data may be aggregated into a series of metrics, such as response time, average time, and other data. Next, the aggregated application data and call chain data may be reported to a controller by the language agent at step 250. The reported aggregated application data and call chain data are associated with a call chain, and is used to correlate with other reported data, such as network flow data and architecture data, at a controller.

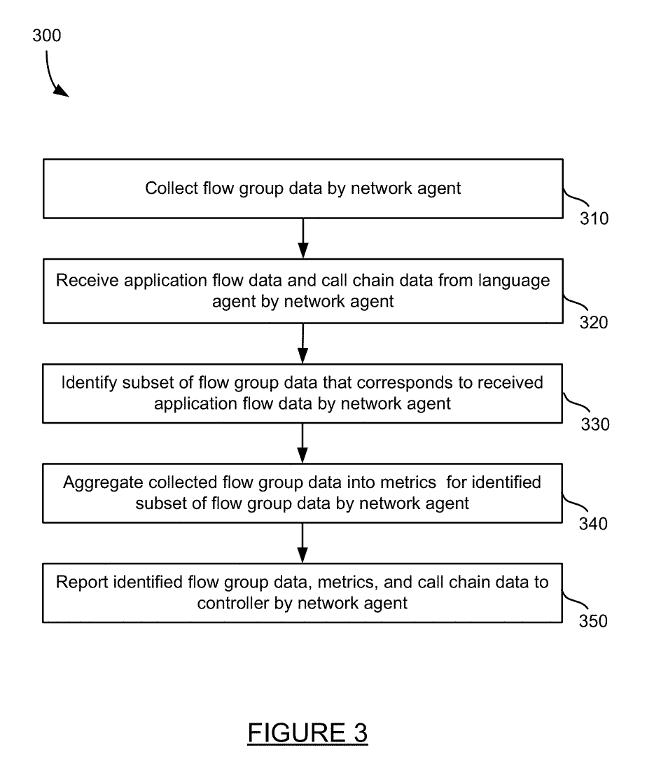

FIG. 3 is an exemplary method for providing a network agent in a monitoring system. Network flow group data and network infrastructure data is collected by a network agent at step 310. The collected data may be collected at a socket and includes network layer data such as source IP, destination port, destination IP, and protocol data. Application flow data and call chain data are received from a language agent by the network agent at step 370. The call chain data and application flow data may be used by the network agent to identify flow group data for processing and reporting to a controller by the network agent. In some instances, a language agent notifies the network agent whenever there is new data about the call chain.

A subset of the network flow group data collected by the network agent is identified at step 330. The subset of the network flow group data that is collected corresponds to application flow data received by the network agent from the language agent. Hence, the network agent identifies flow group data received over a socket that matches application flow data received from the language agent. Next, metrics calculated from the identified network flow group data are aggregated by the network agent. Network flow group data not matching the application flow data is discarded, while network flow group data matching the application flow data is kept and rolled into one or more metrics by the network agent. The aggregated metrics obtained from the identified network flow group data may include TCP throughput, TCP packet loss, latency, bandwidth, and other metrics. After aggregating the metrics, the identified network flow group data and network infrastructure data, metrics, and call chain data may be reported to the controller by the network agent. One or more of the identified network flow group data, network infrastructure data, and metrics may be reported periodically, in response to a request by a controller, or based on some other event.

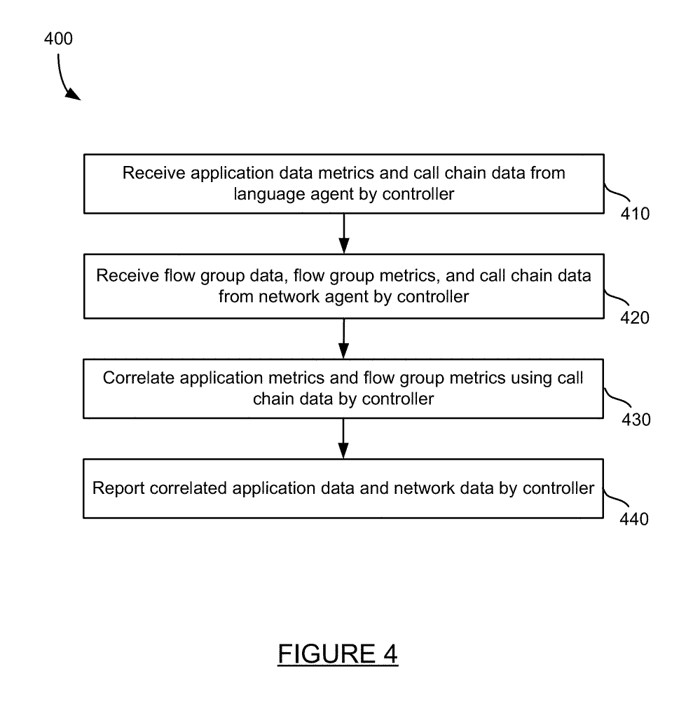

FIG. 4 is an exemplary method for providing a controller and a monitoring system. Application data metrics and call chain data are received from a language agent by a controller at step 410. The identified network flow group data and network infrastructure data, metrics, and call chain data may be received from a network agent by the controller at step 420.

The application data metrics and flow group metrics may be correlated using the call chain data by the controller at step 430. A language agent receives application data from an application being monitored, application flow data from messages received by the application, and call chain data from received requests and the controller. Language agent creates application data metrics from the application data and reports the application flow data and call chain data to the network agent. The language agent also reports the application data, application data metrics, and call chain data to the controller. The application data and application data metrics are associated with a particular distributed transaction through the call chain data which specifies a particular sequence of machines that process a distributed transaction.

A application data metrics and flow group metrics may be correlated using the call chain data by the controller at step 430. A language agent receives application data from an application being monitored, application flow data from messages received by the application, and call chain data from received requests and the controller. Language agent creates application data metrics from the application data and reports the application flow data and call chain data to the network agent. The language agent also reports the application data, application data metrics, and call chain data to the controller. The application data and application data metrics are associated with a particular distributed transaction through the call chain data which specifies a particular sequence of machines that process a distributed transaction.

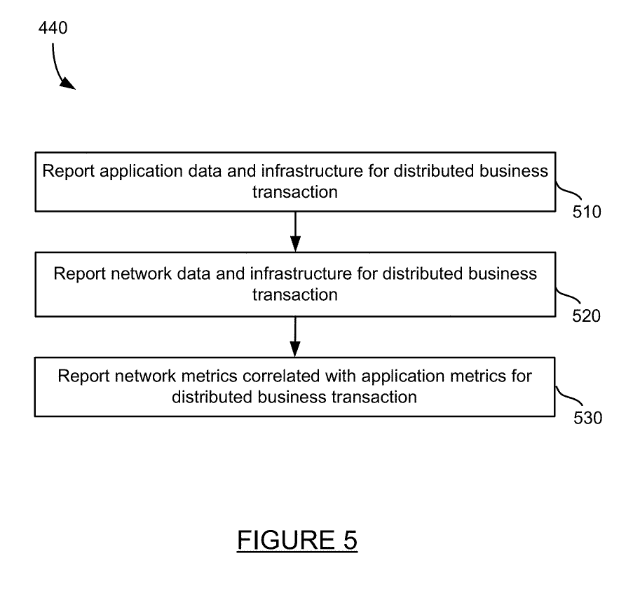

The correlated application data and network data may then be reported to a user by a controller at step 440. Reporting the correlated application data is discussed in more detail below with respect to FIG. 5.

FIG. 5 is an exemplary method for reporting correlated application data and network data. The method of FIG. 5 provides more detail for step 440 of the method of FIG. 4. Application data and application infrastructure data for a distributed business transaction is reported to a user at step 510. The application data and infrastructure data may include an identification of the nodes, the application ID, certain metrics associated with the distributed business transaction architecture such as average response time between nodes that make up the distributed business transaction, and other information regarding the distributed business transaction. The application ID may be based at least in part on the call chain identifier.

Network data and network infrastructure data for a distributed business transaction may be reported at step 520. The network infrastructure data may include the nodes from which a message is sent and received, as well as any intermediary machines, such as a load balancer.

Network generated from network flow group and network infrastructure data (network metrics) may be correlated with the distributed business transaction and be reported at step 530. The metrics may relate to individual network portions or “hops” that may be added together for the distributed business transaction as well as network metrics for the distributed business application as a whole. For example, the network metrics correlated to the distributed business transaction may include the overall latency or throughput in the distributed business application. For overall latency or throughput, the individual latency and throughput may be determine for each “hop” between a set of nodes that comprise the distributed business application. The total latency and/or throughput may then be determined by adding the individual metric values associated with each hop that makes up the overall path of the distributed business transaction.

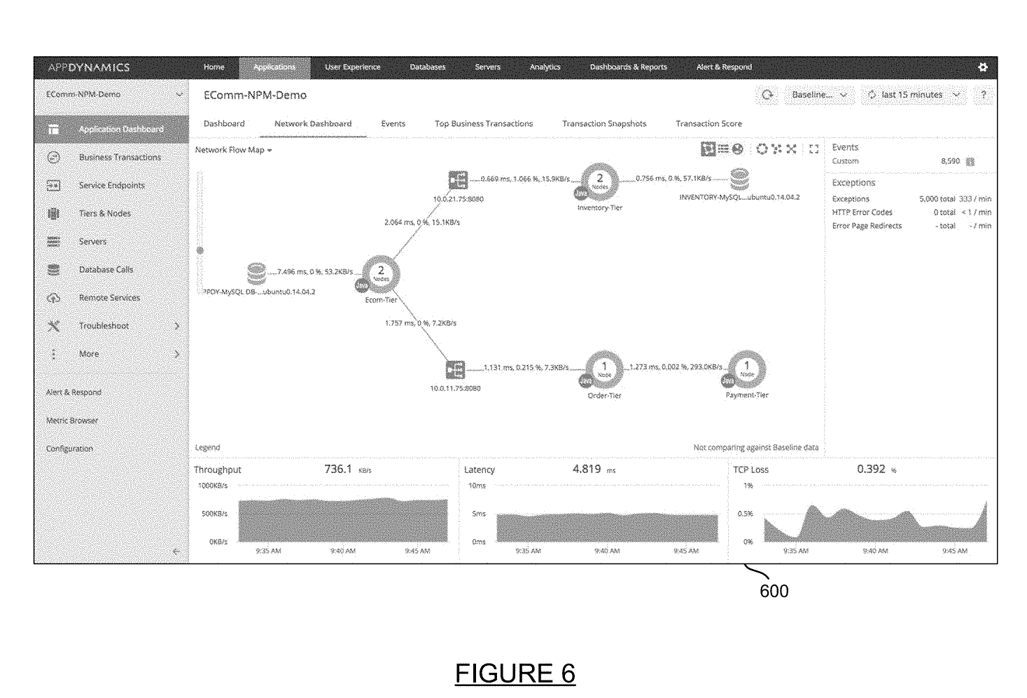

FIG. 6 illustrates an exemplary interface 600 for displaying network metrics for a distributed business transaction. Interface 600 illustrates a distributed architecture system having an “Econ-Tier”, an “Inventory-Tier”, an inventory database, an “Order-Tier”, and a “Payment Tier.” There are load balancers between the Econ Tier and Inventory Tier and Order Tier. Each hop between node, database or load balancer is displayed with an average latency time. The average network latency for a business transaction is based on the path the BT takes through the application tiers, nodes and machines.

The total latency for the business transaction including of the displayed tiers and databases is the sum of latency values associated for each hop in the distributed business transaction. The total latency for a business transaction may be displayed in the interface in some manner, in some instances along with the name of the distributed business transaction. The values in the screenshot on the links are network latency. For example, the business transaction network latency between ECom and the Load Balancer is 2.2 ms. Business transaction network latency for transactions from ECom to Inventory tier will be 2.22 ms+29.43 ms+14.667 ms=46.29 ms, Similarly, the BT network latency for transactions from ECom to Payment will be 2.188 ms+0.006 ms+0.458 ms=2.652 ms. The average latency over time is displayed in graph form towards the bottom of the interface of FIG. 6.

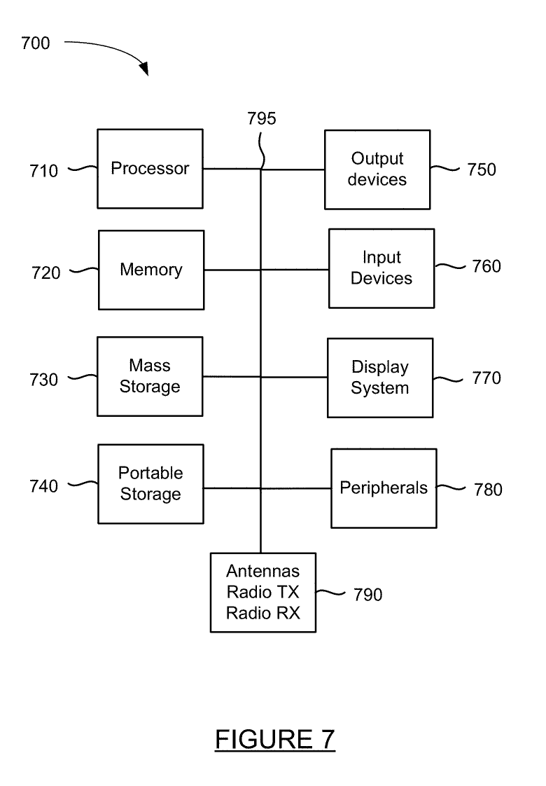

FIG. 7 is a block diagram of an exemplary system for implementing the present technology. System 700 of FIG. 7 may be implemented in the contexts of the likes of client computer 105 and 192, servers 125, 130, 140, 150, and 160, machine 170, data stores 180 and 190, and controller 190. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive, an optical disk drive, a flash drive, or other device, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, USB drive, memory card or stick, or other portable or removable memory, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device. Display system 770 may also receive input as a touch-screen.

Peripherals 780 may include any type of computer support device to add additional functionality to the computer system. For example, peripheral device(s) 780 may include a modem or a router, printer, and other device.

The system of 700 may also include, in some implementations, antennas, radio transmitters and radio receivers 790. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for correlating network performance data with a distributed business transaction, comprising:
collecting, by a first agent installed on a first machine, application data during execution of an application from a plurality of applications that implement a distributed business transaction;
collecting, by a second agent installed on the first machine, network data for a network collected during execution of the application while implementing a portion of the distributed business transaction over the network; and
correlating the network data to a distributed business transaction identifier.
The method of claim 1, further comprising reporting the correlated network data for the distributed business transaction from a remote server.

2. The method of claim 1, wherein the network data includes network flow data and network infrastructure data for the distributed business transaction

3. The method of claim 1, further comprising reporting the correlated network data for the distributed business transaction from a remote server.

4. The method of claim 1, wherein collecting the application data includes:
collecting, by the first agent, distributed transaction information from the application being monitored by the first agent; and
providing, by the first agent, the distributed transaction information to the second agent.

5. The method of claim 4, wherein the distributed transaction information includes a sequence of one or more nodes that have previously processed the distributed business transaction.

6. The method of claim 1, wherein collecting the application data include:
collecting, by the first agent, distributed transaction information and a network flow tuple for the application; and
providing, by the first agent, the distributed transaction information and the network flow tuple to the second agent.

7. The method of claim 6, including:
receiving, by the second agent, the network flow tuple and distributed transaction information;
generating, by the second agent, metrics for network flow group data that matches the received network flow tuple; and
reporting, by the second agent, the metrics for the network flow group data and the distributed transaction information to a remote server.

8. The method of claim 1, wherein correlating includes:
receiving application performance metrics generated from the application data collected by the first agent;
receiving network performance metrics generated from the network data collected by the second agent; and
correlating the application performance metrics and network performance metrics using a call chain of machines that indicate a sequence of machines that have previously processed the distributed transaction are associated with each of the application performance metrics and network performance metrics.

9. The method of claim 1, wherein reporting includes providing a network flow metric for the entire distributed business transaction.

10. A non-transitory computer readable storage medium having embodied thereon a program, the program being executable by a processor to perform a method for correlating network performance data for a distributed business transaction, the method comprising:
collecting, by a first agent installed on a first machine, application data during execution of an application from a plurality of applications that implement a distributed business transaction;
collecting, by a second agent installed on the first machine, network data for a network collected during execution of the application while implementing a portion of the distributed business transaction over the network; and
correlating the network data to a distributed business transaction identifier.

11. The non-transitory computer readable storage medium 10, further comprising reporting the correlated network data for the distributed business transaction from a remote server.

12. The non-transitory computer readable storage medium 10, wherein the network data includes network flow data and network infrastructure data for the distributed business transaction

13. The non-transitory computer readable storage medium 10, further comprising reporting the correlated network data for the distributed business transaction from a remote server.

14. The non-transitory computer readable storage medium 10, wherein collecting the application data includes:
collecting, by the first agent, distributed transaction information from the application being monitored by the first agent; and
providing, by the first agent, the distributed transaction information to the second agent.

15. The non-transitory computer readable storage medium 14, wherein the distributed transaction information includes a sequence of one or more nodes that have previously processed the distributed business transaction.

16. The non-transitory computer readable storage medium 10, wherein collecting the application data include:
collecting, by the first agent, distributed transaction information and a network flow tuple for the application; and
providing, by the first agent, the distributed transaction information and the network flow tuple to the second agent.

17. The non-transitory computer readable storage medium 16, including:
receiving, by the second agent, the network flow tuple and distributed transaction information;
generating, by the second agent, metrics for network flow group data that matches the received network flow tuple; and
reporting, by the second agent, the metrics for the network flow group data and the distributed transaction information to a remote server.

18. The non-transitory computer readable storage medium 10, wherein correlating includes:
receiving application performance metrics generated from the application data collected by the first agent;
receiving network performance metrics generated from the network data collected by the second agent; and
correlating the application performance metrics and network performance metrics using a call chain of machines that indicate a sequence of machines that have previously processed the distributed transaction are associated with each of the application performance metrics and network performance metrics.

19. The non-transitory computer readable storage medium 10, wherein reporting includes providing a network flow metric for the entire distributed business transaction.

20. A system for correlating network performance data for a distributed business transaction, comprising:
a server including a memory and a processor; and
one or more modules stored in the memory and executed by the processor to collect, by a first agent installed on a first machine, application data during execution of an application from a plurality of applications that implement a distributed business transaction, collect, by a second agent installed on the first machine, network data for a network collected during execution of the application while implementing a portion of the distributed business transaction over the network, and correlate the network data to a distributed business transaction identifier.
